(19) United States
(12) Patent Application Publication
(10) Pub. No.: US 2012/0255404 A1
(43) Pub. Date: Oct. 11, 2012

(54) ELECTRONIC TORQUE WRENCH WITH A ROTATABLE DISPLAY UNIT

(75) Inventors: Yeh-Ching CHANG, Taichung City (TW); Hsien-Cheng Lin, Taichung City (TW)

(73) Assignee: Yeh-Ching CHANG

(21) Appl. No.: 13/083,242

(22) Filed: Apr. 8, 2011

(51) Int. Cl. B25B 23/144

(52) U.S. Cl. 81/479

(57) ABSTRACT

An electronic torque wrench includes a wrench head unit adapted to engage and turn a fastener, a tubular wrench body which includes a front tubular end fittingly engaged and secured with the wrench head unit, and an intermediate tubular segment having an access opening, a grip handle which is configured to securely grip a rear tubular end of the tubular wrench body, a mounting shell which is sleeved on the intermediate tubular segment, and which has an access hole communicated with the access opening, a housing sleeve sleeved on, and rotatable relative to the mounting shell about a lengthwise axis, and a display unit disposed on the housing sleeve to provide a display representing a torque measured by a strain gauge on the wrench head unit. By rotating the housing sleeve, the display unit can be adjusted to a desired angular position for being viewed easily by the user.

### BACKGROUND OF THE INVENTION

1. Field of the Invention

This invention relates to an electronic torque wrench, more particularly to an electronic torque wrench with a rotatable display unit to be easily viewed by a user.

2. Description of the Related Art

Referring to FIG. 1, a conventional electronic torque wrench 10 is shown to include a head 11 for engaging and turning a fastener, a handle 12 extending from the head 11 to be held by a user for operating the head 11, and a display 13 coupled to a strain gauge assembly disposed in the handle 12 for displaying information of torque detected by the strain gauge assembly. In operation, the user grips and turns the handle 12, and observes the display 13 to read numerical data of the measured torque of the wrench 10 until the fastener is fastened with a desired torque.

However, since the display 13 is affixed to the handle 12, and is turned therewith during operation, the display 13 may not be kept in a position to be in full view of the user, particularly when the torque wrench 10 is used to operate fasteners at different positions, thereby rendering operation inconvenient.

### SUMMARY OF THE INVENTION

An object of the present invention is to provide an electronic torque wrench which has a rotary display unit rotatable relative to a handle so as to be easily viewed by the user during operation.

According to this invention, the electronic torque wrench includes a wrench head adapted to engage and turn a fastener about a torque axis, a joint segment extending radially from the wrench head relative to the torque axis for mounting a strain gauge thereon, a tubular wrench body which defines a passage that extends along a lengthwise axis, and which includes a front tubular end fittingly engaged and secured with the joint segment, a rear tubular end opposite to the front tubular end, and an intermediate tubular segment having an access opening that extends radially to communicate with the passage, a grip handle which is configured to securely grip the rear tubular end of the tubular wrench body so as to permit the tubular wrench body to transmit a torque applied on the grip handle to the wrench head, a mounting shell which is sleeved on the intermediate tubular segment and forwardly from the grip handle, and which has an access hole extending to communicate with the access opening, a housing sleeve sleeved on, and rotatable relative to the mounting shell about the lengthwise axis, and a display unit disposed on the housing sleeve to provide a display representing a torque measured by the strain gauge. By rotating the housing sleeve about the lengthwise axis, the display unit can be adjusted to a desired angular position to be viewed by the user.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a perspective view of a conventional electronic torque wrench;

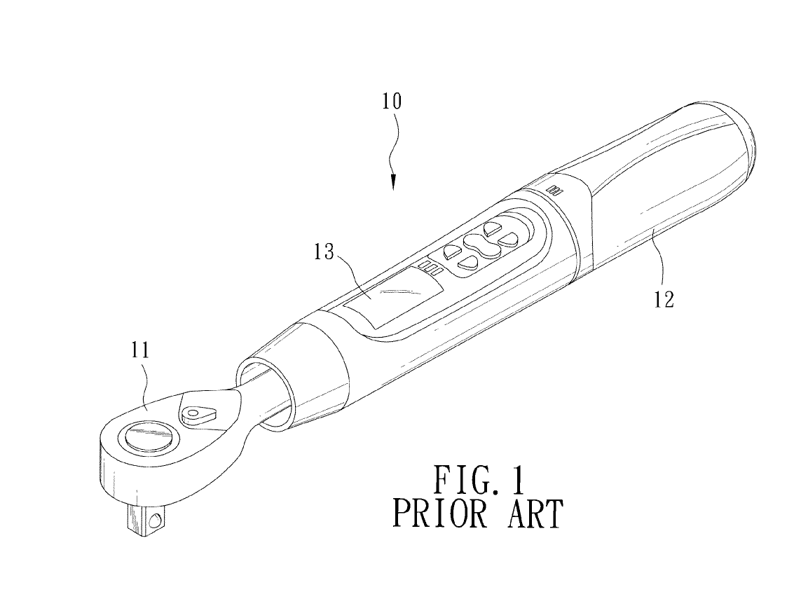

FIG. 2 is a perspective view of the preferred embodiment of an electronic torque wrench according to this invention;

FIG. 3 is an exploded perspective view of the preferred embodiment;

FIG. 4 is a perspective view of a housing sleeve of the preferred embodiment;

FIG. 5 is a sectional view of the preferred embodiment;

FIG. 6 is a cross-sectional view of the preferred embodiment taken along line VI-VI of FIG. 5;

FIG. 7 is a schematic side view showing the preferred embodiment during operation;

FIG. 8 is a cross-sectional view similar to FIG. 6, showing the housing sleeve in another angular position; and

FIG. 9 is a schematic side view showing the preferred embodiment in the state where the housing sleeve is in another angular position.

### DETAILED DESCRIPTION OF THE PREFERRED EMBODIMENT

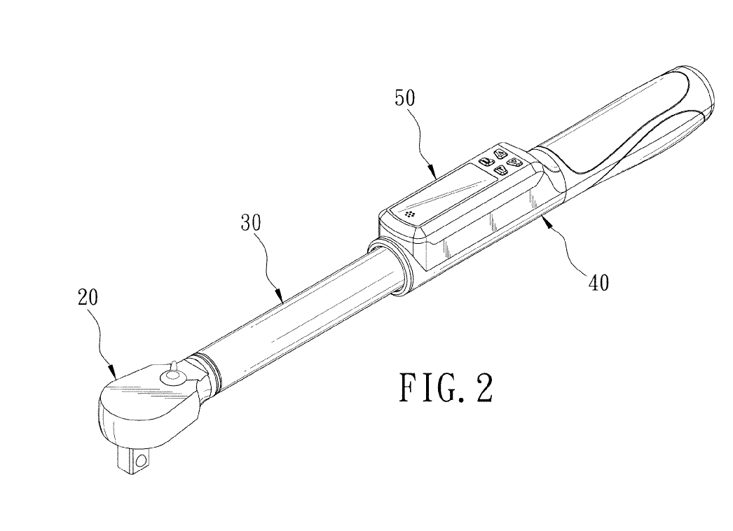

Referring to FIG. 2, the preferred embodiment of an electronic torque wrench according to the present invention is shown to comprise a head unit 20, a body unit 30, a housing sleeve 40, and a display unit 50.

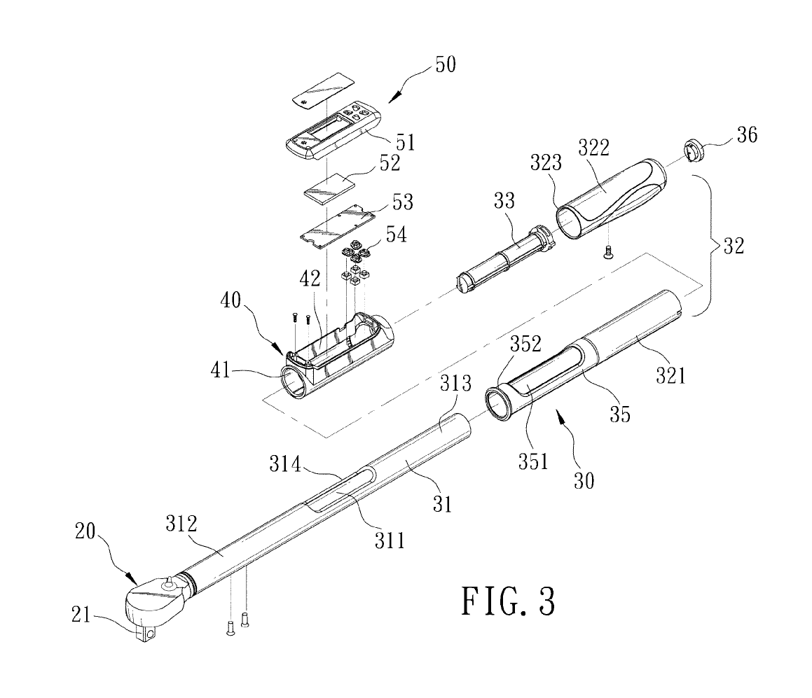

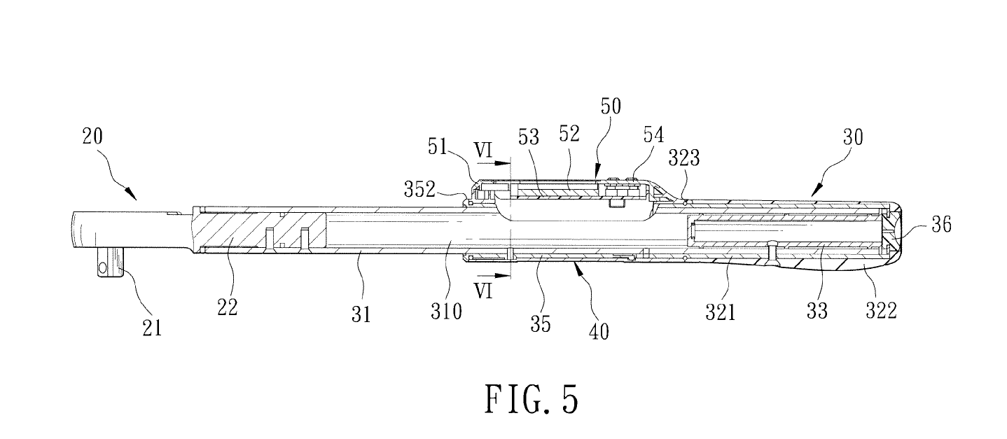

Referring to FIGS. 3 to 5, the head unit 20 includes a wrench head 21 adapted to engage and turn a fastener about a torque axis, and a joint segment 22 integrally formed with and extending radially from the wrench head 21 relative to the torque axis for mounting a strain gauge (not shown) thereon.

The body unit 30 includes a tubular wrench body 31, a grip handle 32, a mounting shell 35, and a battery pack 33. The tubular wrench body 31 defines a passage 310 which extends along a lengthwise axis, and includes a front tubular end 312 fittingly engaged and secured with the joint segment 22, a rear tubular end 313 opposite to the front tubular end 312, and an intermediate tubular segment 314 which is disposed between the front and rear tubular ends 312, 313, and which has an access opening 311 that extends radially to communicate with the passage 310. The grip handle 32 includes a tubular mount 321 sleeved on, and secured to the rear tubular end 313 of the tubular wrench body 31, and a handgrip 322 securely sleeved on the tubular mount 321 so as to permit the tubular wrench body 31 to transmit a torque applied on the grip handle 32 to the head unit 20. The handgrip 322 extends forwardly to terminate at a front sleeve end 323. The mounting shell 35 is integrally formed with and extends forwardly from the tubular mount 321 to be sleeved on the intermediate tubular segment 314, and has an access hole 351 extending to communicate with the access opening 311, and a front flange 352 spaced apart from the front sleeve end 323 of the handgrip 322. The battery pack 33 is disposed in the passage 310 at the rear tubular end 313 of the tubular wrench body 31 for receiving batteries (not shown) to supply power. An end cap 36 is disposed to close rear opened ends of the battery pack 33 and the grip handle 32.

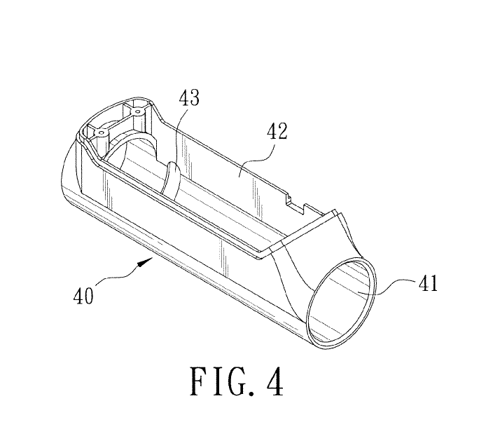

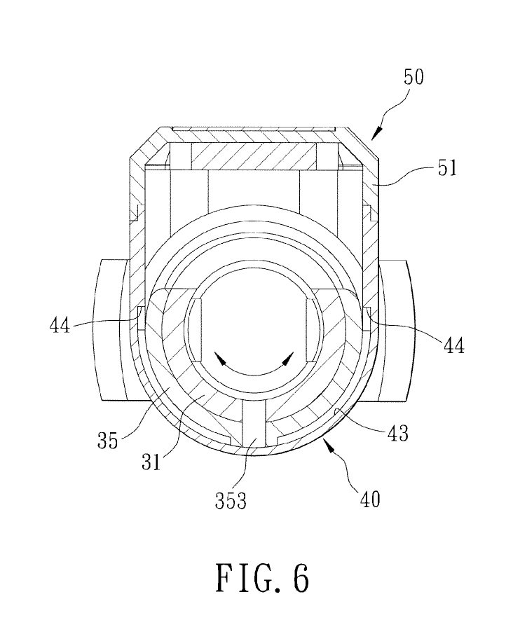

The housing sleeve 40 is sleeved on, and rotatable relative to the mounting shell 35 about the lengthwise axis, and is confined between the front flange 352 and the front sleeve end 323 to be guarded against movement relative to the mounting shell 35 along the lengthwise axis. Specifically, as shown in FIGS. 4 and 6, the housing sleeve 40 has an inner tubular wall 41 which is rotatably sleeved on the mounting shell 35 and which has an arcuate key slot 43 that angularly extends about the lengthwise axis to terminate at two end barriers 44. The mounting shell 35 has a key 353 which extends radially to be slidably engaged in the key slot 43 so as to guide and limit the extent of rotation of the housing sleeve 40 relative to the mounting shell 35. Moreover, the housing sleeve 40 has an outer tubular wall which defines a rectangular recess 42 that extends through the inner tubular wall 41.

The display unit 50 is fitted in the rectangular recess 42, and includes a face panel 51, an LCD screen 52, a circuit board 53 and a plurality of key pads 54, which are electronically connected to the battery pack 33 and the strain gauge in any known way so as to provide a display representing a torque measured by the strain gauge.

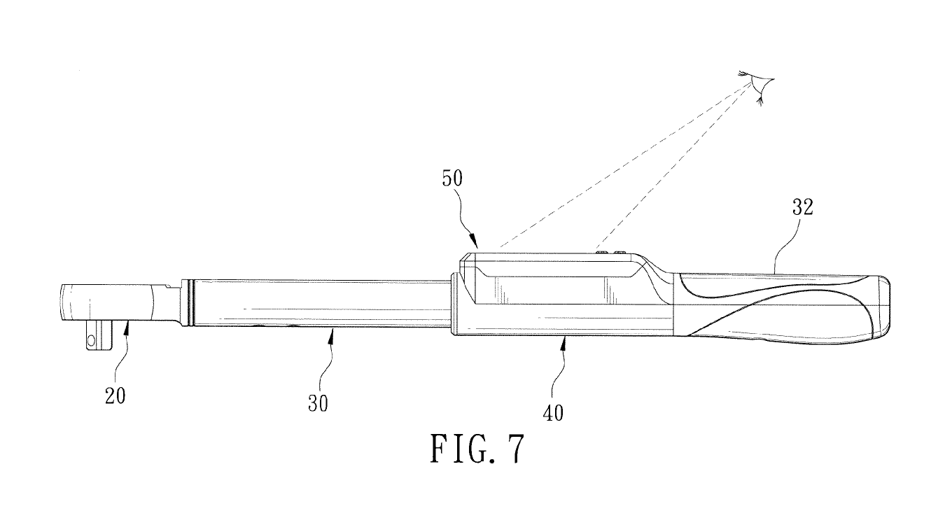

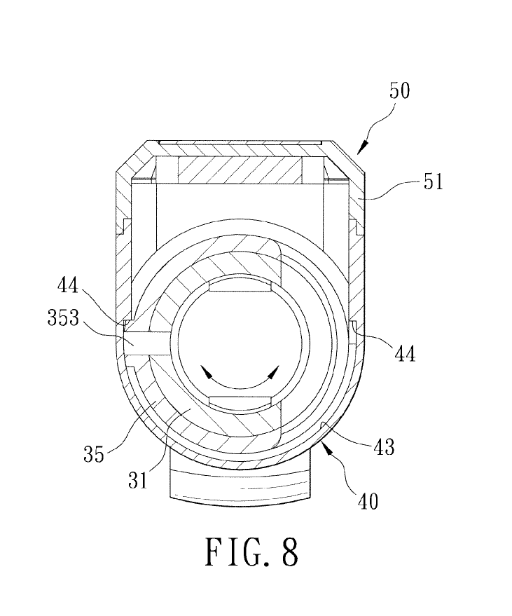

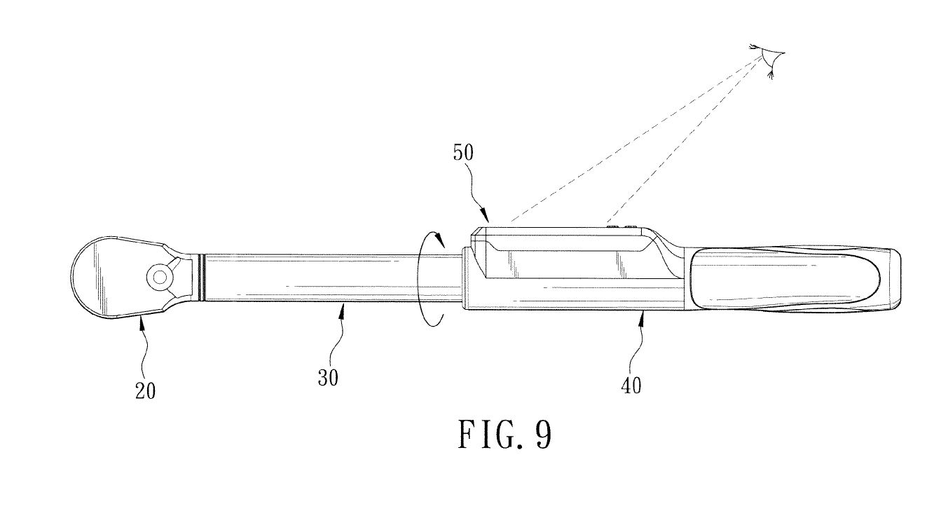

Referring to FIG. 7, in use, the user grips the grip handle 32 to apply a torque thereon, and can observe the display unit 50 to read numerical data of the measured torque. Referring to FIGS. 8 and 9, when the electronic torque wrench is turned to a different angular position as shown, the user can rotate the housing sleeve 40 about the lengthwise axis to allow the display unit 50 to be uninterruptedly viewed by the user. On the other hand, the user can adjust the angular position of the housing sleeve 40 to keep the display unit 50 at his/her visible sight without varying the posture, thereby rendering operation of the electronic torque wrench convenient.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

What is claimed is:

1. An electronic torque wrench comprising:
a wrench head which is adapted to engage and turn a fastener about a torque axis;
a joint segment extending radially from said wrench head relative to the torque axis for mounting a strain gauge thereon;
a tubular wrench body which defines a passage that extends along a lengthwise axis, and which includes
a front tubular end fittingly engaged and secured with said joint segment,
a rear tubular end opposite to said front tubular end, and
an intermediate tubular segment disposed between said front and rear tubular ends, and having an access opening that extends radially to communicate with said passage;
a grip handle which is configured to securely grip said rear tubular end of said tubular wrench body so as to permit said tubular wrench body to transmit a torque applied on said grip handle to said wrench head;
a mounting shell which is sleeved on said intermediate tubular segment and forwardly from said grip handle, and which has an access hole extending to communicate with said access opening;
a housing sleeve sleeved on, and rotatable relative to said mounting shell about the lengthwise axis; and
a display unit disposed on said housing sleeve to provide a display representing a torque measured by the strain gauge.

2. The electronic torque wrench according to claim 1, wherein said housing sleeve has an inner tubular wall which is rotatably sleeved on said mounting shell and which has an arcuate key slot that angularly extends about the lengthwise axis to terminate at two end barriers, said mounting shell having a key which extends radially to be slidably engaged in said key slot so as to guide and limit the extent of rotation of said housing sleeve relative to said mounting shell.

3. The electronic torque wrench according to claim 2, wherein said housing sleeve has an outer tubular wall which defines a rectangular recess that extends through said inner tubular wall to permit said display unit to be fitted therein.

4. The electronic torque wrench according to claim 1, wherein said grip handle includes a tubular mount which extends rearwardly from said mounting shell to be sleeved on, and secured to said rear tubular end of said tubular wrench body, and a handgrip which is securely sleeved on said tubular mount.

5. The electronic torque wrench according to claim 4, wherein said handgrip extends forwardly to terminate at a front sleeve end, said mounting shell having a front flange which is spaced apart from, and which in cooperation with said front sleeve end to guard against movement of said housing sleeve relative to said mounting shell along the lengthwise axis.

6. The electronic torque wrench according to claim 1, further comprising a battery pack disposed in said passage at said rear tubular end of said tubular wrench body.

7. The electronic torque wrench according to claim 1, wherein said joint segment is integrally formed with said wrench head.
